(19) United States
(12) Patent Application Publication
(10) Pub. No.: US 2007/0002293 A1
(43) Pub. Date: Jan. 4, 2007

(54) Method measuring distortion using exposure equipment

(76) Inventors: Dong-woon Park, Anyang-si (KR); Sang-gyun Woo, Yongin-si (KR)

Correspondence Address: VOLENTINE FRANCOS, & WHITT PLLC, ONE FREEDOM SQUARE, 11951 FREEDOM DRIVE SUITE 1260, RESTON, VA, 20190, US

(21) Appl. No.: 11/475,909

(22) Filed: Jun. 28, 2006

(30) Foreign Application Priority Data
Jun. 30, 2005 (KR) 10-2005-0057651

(51) Int. Cl. G03B 27/68

(52) U.S. Cl. 355/52; 355/55

(57) ABSTRACT

A method of measuring distortion for an exposure apparatus is disclosed and comprises; aligning a reticle comprising a plurality of measuring patterns over a first wafer, wherein the plurality of measuring patterns are separated by a first pitch in a first direction and a second pitch in a second direction orthogonal to the first direction, forming a plurality of first exposure patterns on the first wafer by performing a first exposure process through the reticle, shifting the reticle by a first distance from a position at which the first exposure process was performed and aligning the reticle over the first wafer, forming a plurality of second exposure patterns on the first wafer by performing a second exposure process through the reticle, aligning the reticle over a second wafer, forming a plurality of third exposure patterns on the second wafer by performing a third exposure process though the reticle, shifting the reticle by a second distance from a position where the third exposure process was performed and aligning the reticle over the second wafer, forming a plurality of fourth exposure patterns on the second wafer by performing a fourth exposure process through the reticle, calculating a first relative error between the first exposure patterns and the second exposure patterns in the first direction, and calculating a second relative error between the third exposure patterns and the fourth exposure patterns in the second direction, and measuring distortion for the exposure apparatus in the first direction using the first relative error and measuring distortion for the exposure apparatus in the second direction using the second relative error.

### BACKGROUND OF THE INVENTION

1. Field of the Invention

Embodiments of the invention relate to a semiconductor exposure equipment. More particularly, embodiments of the invention relate to a method of measuring an absolute distortion value associated with semiconductor exposure equipment.

This application claims the benefit of Korean Patent Application No. 2005-0057651 filed Jun. 30, 2005, the subject matter of which is hereby incorporated by reference in its entirety.

2. Description of the Related Art

As line widths for elements associated with semiconductor devices continue to decrease, the overlay accuracy of exposure equipment becomes increasingly important to various fabrication processes. “Overlay” is the superposition of patterns associated with two or more successive fabrication processes. The accuracy with which a single piece of fabrication equipment projects patterns onto a target wafer, as well as the relative accuracy of multiple pieces of equipment overlay various patterns on the target wafer are both vital to determining overlay accuracy.

For example, as illustrated in FIG. 1, a target wafer 10 is exposed through an exposure apparatus defining a one-shot region 11, and distortion 13 is generated in one-shot region 11. The distribution of this distortion will be different for different exposure apparatuses. In order to improve overall overlay accuracy, each exposure apparatus potentially contributing distortion to the overlay should be accounted for and its relative distortion effect understood. Thus, it is important to accurately measure the distortion of various exposure apparatuses to improve the overall overlay accuracy associated with a target wafer.

In order to measure the distortion of an exposure apparatus, a standard target wafer is generally associated with an orthogonally laid out base grid. The base grid is used to measure the distortion. For example, referring to FIG. 2, distortion may be measured by determining a difference between an orthogonal base grid 21 and an actual grid 22 apparent on a wafer after exposure. Orthogonal grid 21 may be formed on the wafer using conventional processes, such as exposure and etching. The positioning of orthogonal grid 21 on the wafer may be precisely controlled using conventionally understood measurement devices. Once orthogonal grid 21 is scribed onto the wafer, it may be loaded into an exposure apparatus. The exposure apparatus may then be used to project an actual grid 22, having the same pattern as orthogonal grid 21, onto the wafer through the exposure process. Differences (e.g., relative error) between the ideal orthogonal grid 21 and the resulting grid 22 actually formed on the wafer may be used to understand and quantify the distortion inherent in the projection process associated with the exposure process as performed by the exposure apparatus.

Thus, according to conventional practice, the accuracy with which overlay distortion is measured is a function of orthogonal grid 21 projected on the wafer. Ideally, orthogonal grid 21 is correctly indicated on the wafer, as positioned by the applicable very precise measuring device. However, orthogonal grid 21 may be altered as the wafer is being handled (e.g., the loading/unloading of a wafer from an exposure apparatus), or an error may occur in the operation of the precise measuring device, etc. As a result of these and other ill-influences, there is a practical limit to accuracy with which distortion 13 formed on wafer 10 may be measured.

Another way of measuring the distortion related to a particular exposure apparatus suggests forming a reference grid on a wafer through an exposure process and then exposing a single cell of the resulting grid using a stepping motion to measure the inherent distortion. However, this method requires that each and every cell of the reference grid be exposed independently using the stepping motion. In addition to being time consuming, this approach is no more accurate than the precision with which the stepping motion is conducted.

In sum, the conventional methods of measuring the distortion of an exposure apparatus are inadequate to current applications, and it remains very difficult and very inconvenient to measure the distortion. As a practical result of realities, an exposure apparatus is generally set as a “standard” and the distortion of the standard exposure apparatus is measured. Thereafter, the distortion of other exposure apparatuses is determined and compensated in relation to the distortion of the standard exposure apparatus. However, this approach does not account for the inevitable changes over time in the distortion of the standard exposure apparatus.

### SUMMARY OF THE INVENTION

In one embodiment, the invention provides a method of measuring distortion for an exposure apparatus, the method comprising; aligning a reticle comprising a plurality of measuring patterns over a first wafer, wherein the plurality of measuring patterns are separated by a first pitch in a first direction and a second pitch in a second direction orthogonal to the first direction, forming a plurality of first exposure patterns on the first wafer by performing a first exposure process through the reticle, shifting the reticle by a first distance from a position at which the first exposure process was performed and aligning the reticle over the first wafer, forming a plurality of second exposure patterns on the first wafer by performing a second exposure process through the reticle, aligning the reticle over a second wafer, forming a plurality of third exposure patterns on the second wafer by performing a third exposure process though the reticle, shifting the reticle by a second distance from a position where the third exposure process was performed and aligning the reticle over the second wafer, forming a plurality of fourth exposure patterns on the second wafer by performing a fourth exposure process through the reticle, calculating a first relative error between the first exposure patterns and the second exposure patterns in the first direction, and calculating a second relative error between the third exposure patterns and the fourth exposure patterns in the second direction, and measuring distortion for the exposure apparatus in the first direction using the first relative error and measuring distortion for the exposure apparatus in the second direction using the second relative error.

In another embodiment, the invention provides a method of measuring distortion for an exposure apparatus, the method comprising; aligning a reticle comprising a plurality of measuring patterns over a wafer, wherein the plurality of measuring patterns are separated by a first pitch in a first direction and a second pitch in a second direction, forming a plurality of first exposure patterns by performing a first exposure process through the reticle, shifting the reticle by a first distance from a position at which the first exposure process was performed and aligning the reticle over the first wafer, forming a plurality of second exposure patterns by performing a second exposure process through the reticle, shifting the reticle by a second distance from a position where the first exposure process was performed and aligning the reticle over the wafer, forming a plurality of third exposure patterns by performing a third exposure process through the reticle, calculating a first relative error between the first exposure patterns and the second exposure patterns in the first direction, and calculating a second relative error between the first exposure patterns and the third exposure patterns in the second direction, and measuring the distortion of the exposure apparatus in the first direction using the first relative error and measuring the distortion of the exposure apparatus in the second direction using the second relative error.

### BRIEF DESCRIPTION OF THE DRAWINGS

FIG. 1 is a diagram illustrating a distribution of distortion of a conventional semiconductor exposure apparatus;

FIG. 2 is a view illustrating a method of measuring distortion of the conventional semiconductor exposure apparatus;

FIG. 3A is a view of a reticle used to measure the distortion of an exposure apparatus according to an embodiment of the present invention;

FIG. 3B is a view of a reticle used to measure the distortion of an exposure apparatus according to another embodiment of the present invention;

FIG. 4 is a flow chart illustrating a method of measuring the distortion of an exposure apparatus according to an embodiment of the present invention;

FIGS. 5A through 5F are views of exposure patterns for illustrating the method of measuring the distortion of exposure apparatus illustrated in FIG. 4 using the reticle of FIG. 3A;

FIGS. 6A through 6F are views of exposure patterns for illustrating the method of measuring the distortion of an exposure apparatus illustrated in FIG. 4 using the reticle of FIG. 3B;

FIG. 7 is a flow chart illustrating a method of measuring the distortion of an exposure apparatus according to another embodiment of the present invention;

FIGS. 8A through 8D are views of exposure patterns for illustrating the method of measuring the distortion of exposure apparatus illustrated in FIG. 7 using the reticle of FIG. 3A; and

FIGS. 9A through 9D are views of exposure patterns for illustrating the method of the distortion of the exposure apparatus illustrated in FIG. 7 using the reticle of FIG. 3B.

### DESCRIPTION OF EXEMPLARY EMBODIMENTS

Embodiments of the invention will now be described with reference to the accompanying drawings. The invention may, however, be embodied in many different forms and should not be construed as being limited to only the embodiments set forth herein. Rather, these embodiments are presented as teaching examples. Throughout the description and drawings, like reference numerals indicate like elements.

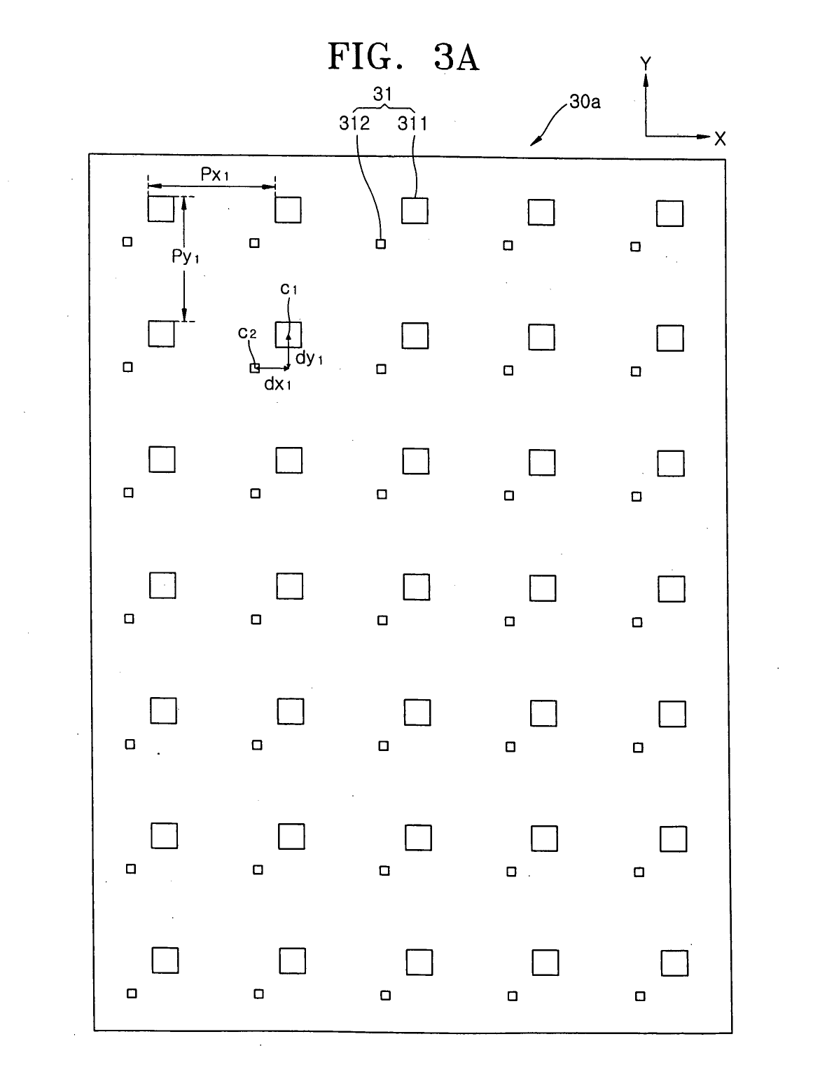

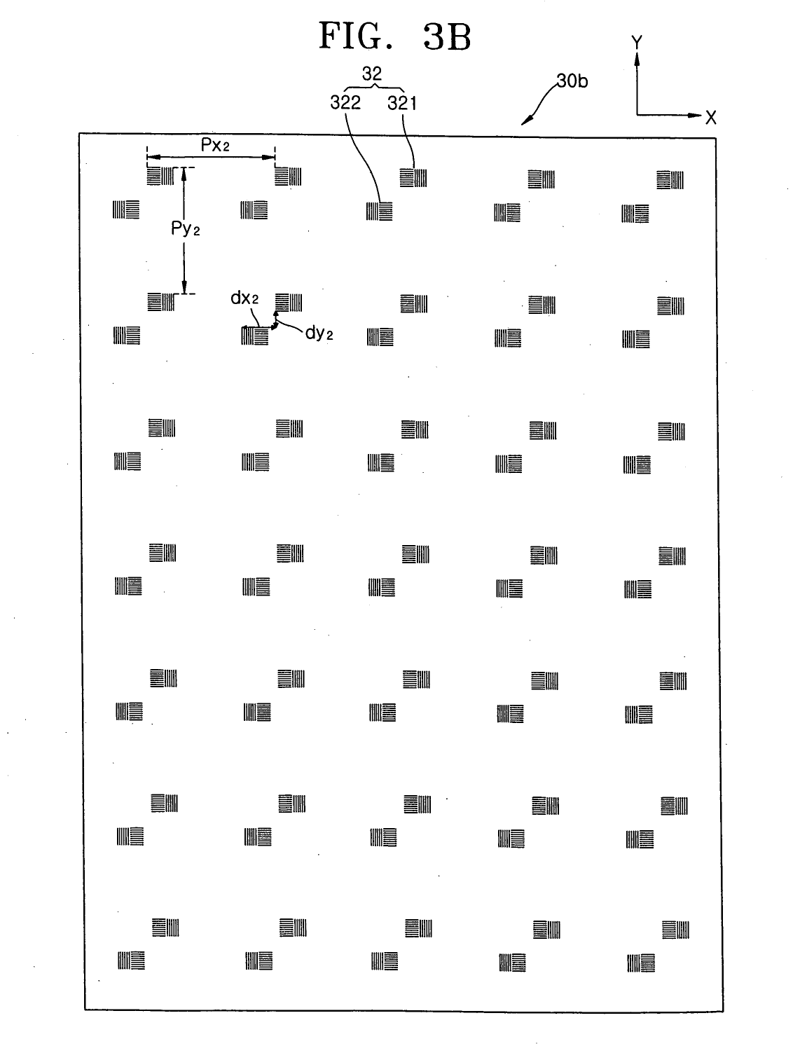

FIG. 3A is a view of an exemplary reticle 30a used to measure distortion for exposure apparatus adapted for use in the fabrication of semiconductor devices and in accordance with an embodiment of the invention. Referring to FIG. 3A, reticle 30a comprises a plurality of measuring patterns 31 arranged according to a defined grid pattern (e.g., in orthogonal X and Y directions). Measuring patterns 31 are arranged at predetermined intervals defined, for example, by first pitches (Px1) in the X direction and second pitches (Py1) in the Y direction.

Each measuring pattern 31 comprises a main scale 311 and a sub-scale 312. Respective main scale 311 and sub-scale 312 are separated from each other by first and second interval distances (dx1 and dy1 in the X and Y directions, respectively). Main scales 311 and sub-scales 312 may take the form of rectangular boxes. First distance (dx1) between main scale 311 and sub-scale 312 is measured between a first center C1 of main scale 311 and a second center C2 of sub-scale 312 in the X direction. Second distance (dy1) between main scale 311 and sub-scale 312 is measured between center C1 of main scale 311 and center C2 of sub-scale 312 in the Y direction.

FIG. 3B is a view of another reticle 30b used to measure distortion for exposure apparatus adapted for use in the fabrication of semiconductor devices and in accordance with another embodiment of the invention. Referring to FIG. 3B, reticle 30b comprises a plurality of measuring patterns 32 having line and space patterns. Measuring patterns 32 are arranged at predetermined intervals defined, for example, by first pitches (Px2) in the X direction and second pitches (Py2) in the Y direction.

Each measuring pattern 32 comprises a main scale 321 and a sub-scale 322. Main scale 321 and sub-scale 322 are separated from each other by appropriate first and second distances (dx2 and dy2). First distance (dx2) is measured between main scale 321 and sub-scale 322 in the X direction, and second distance (dy1) is measured between main scale 321 and sub-scale 322 in the Y direction.

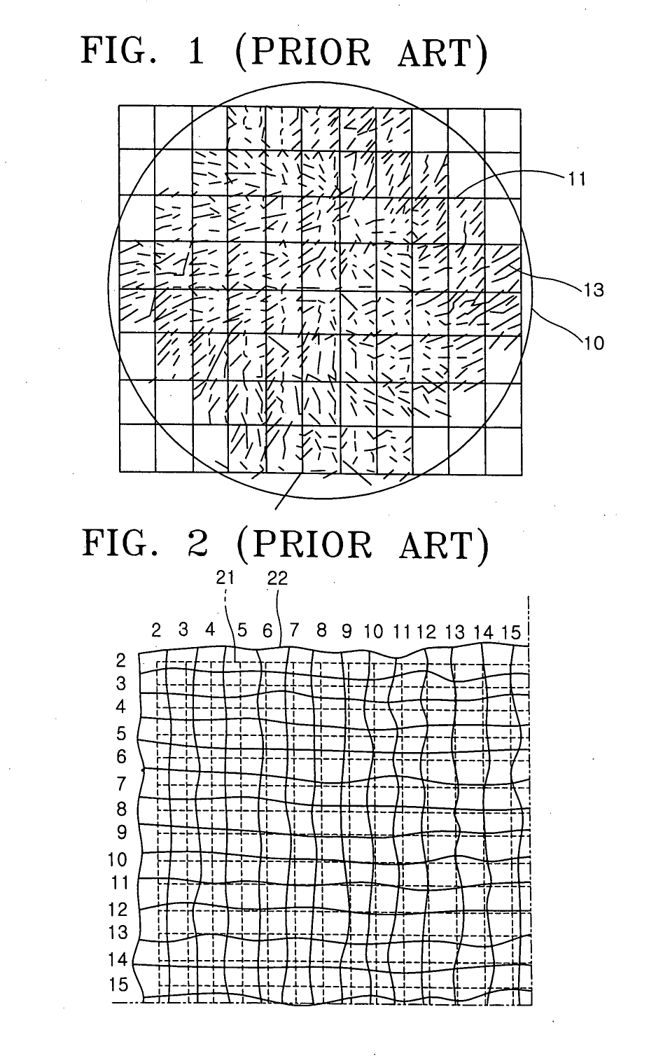

When a wafer is exposed using reticles 30a and 30b shown in FIGS. 3A and 3B, a one-shot region is formed on the wafer, as shown in FIG. 1. The “one-shot region” is a region generated when a wafer is exposed one time through a reticle. Exposure patterns corresponding to the various measuring patterns of reticles 30a and 30b are formed in the one-shot region. Measuring patterns 31 and 32 of the reticles 30a and 30b are not limited to the rectangular box shapes or to the line and space shapes illustrated, but may be formed with various shapes so long as respective main scales and sub-scales are separated from one another by predetermined distances. In addition, the separation and arrangement of distances between the main scales and associated sub-scales of a measuring pattern formed on a reticle adapted for use within the context of present invention may have any reasonable definition and do not need to necessarily be orthogonal in nature. As illustrated in exemplary reticles 30a and 30b, there should be a sufficiently great numbers of measuring patterns (e.g., 31 and 32) in order to provide the accuracy in the measurement of distortion. Further, embodiments of the invention contemplate the formation of one or more groups of measuring patterns on a one-shot region.

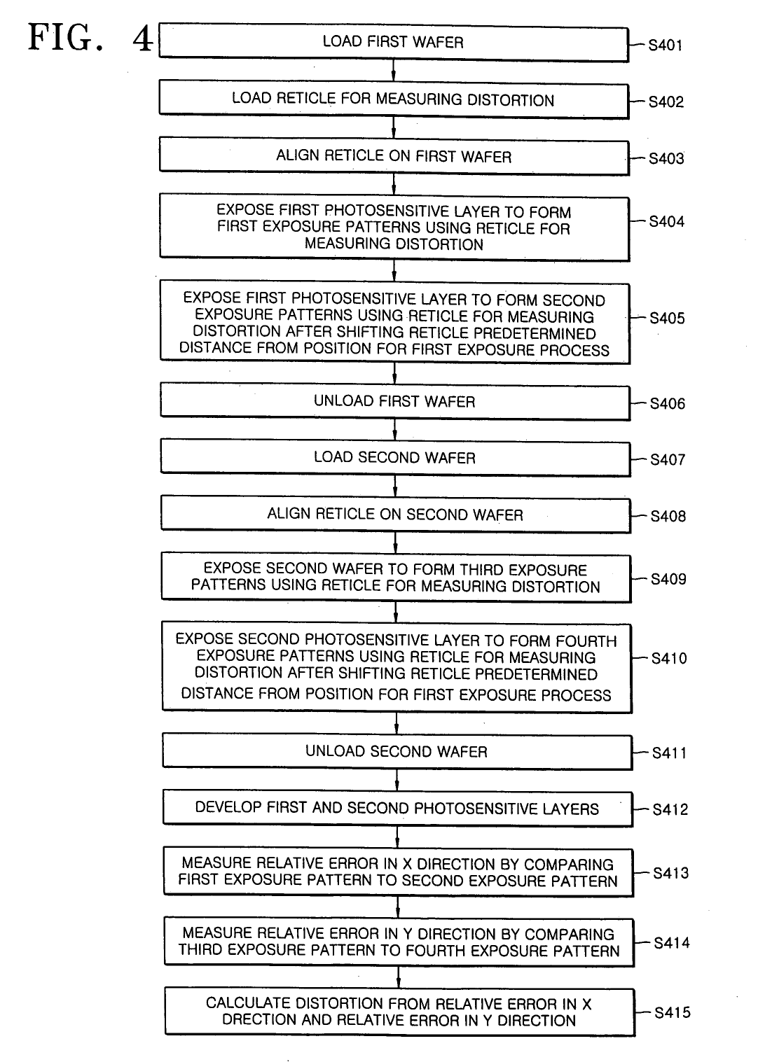

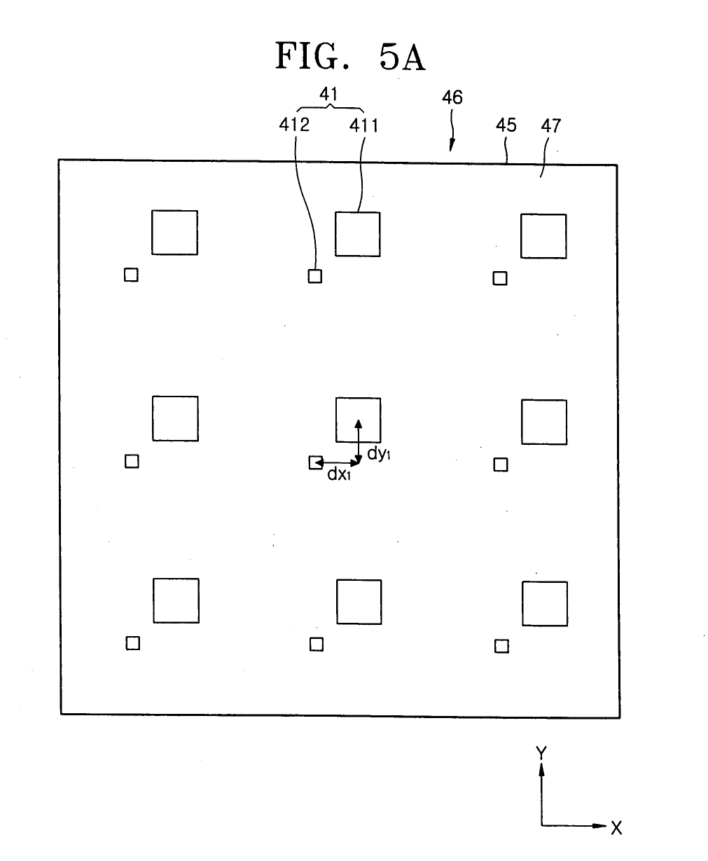

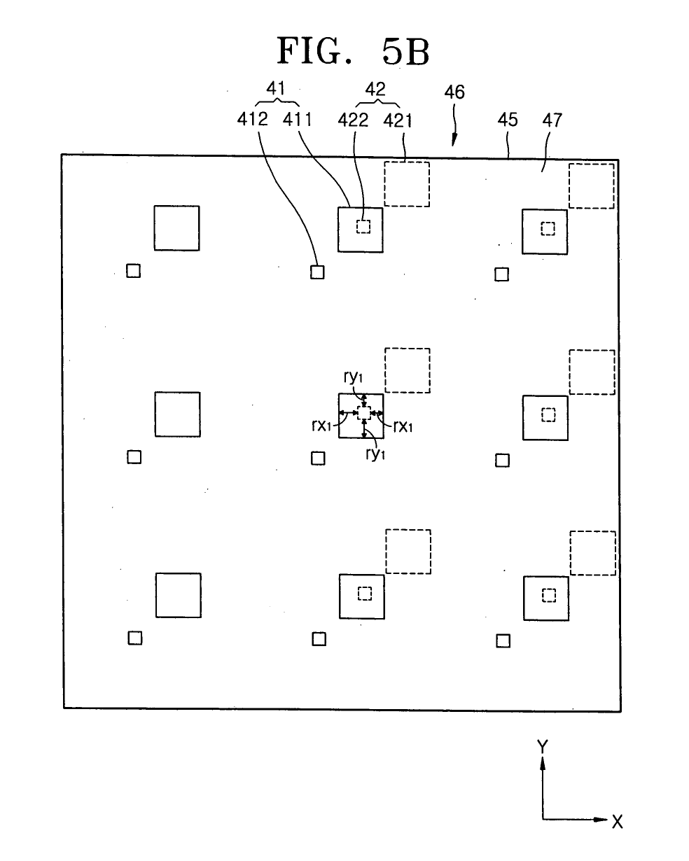

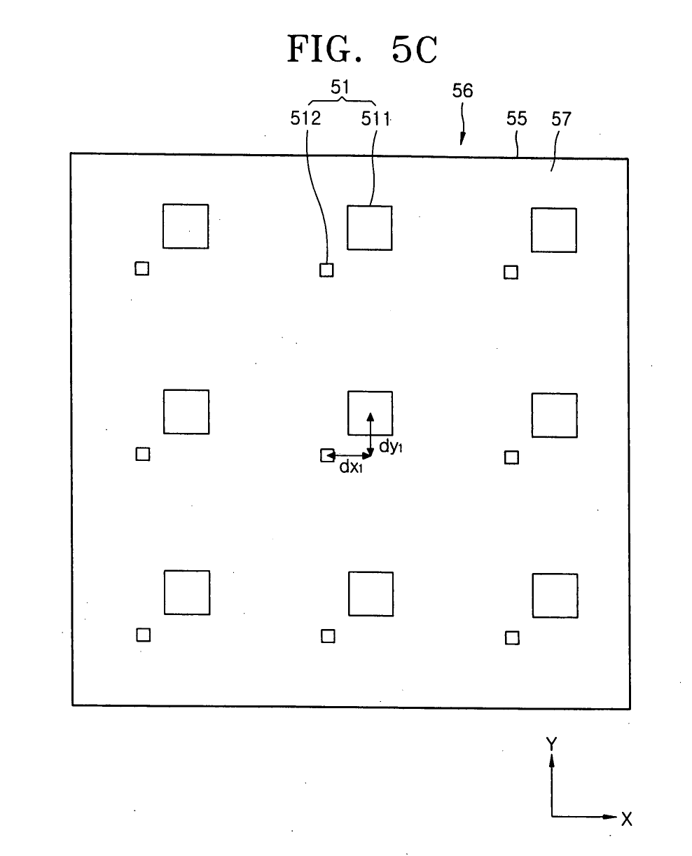

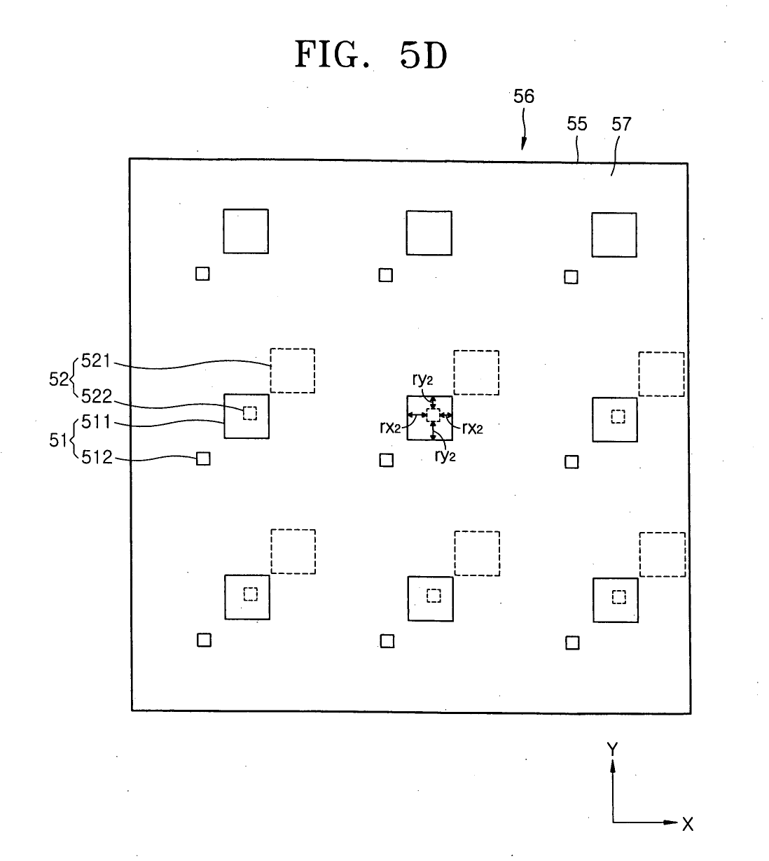

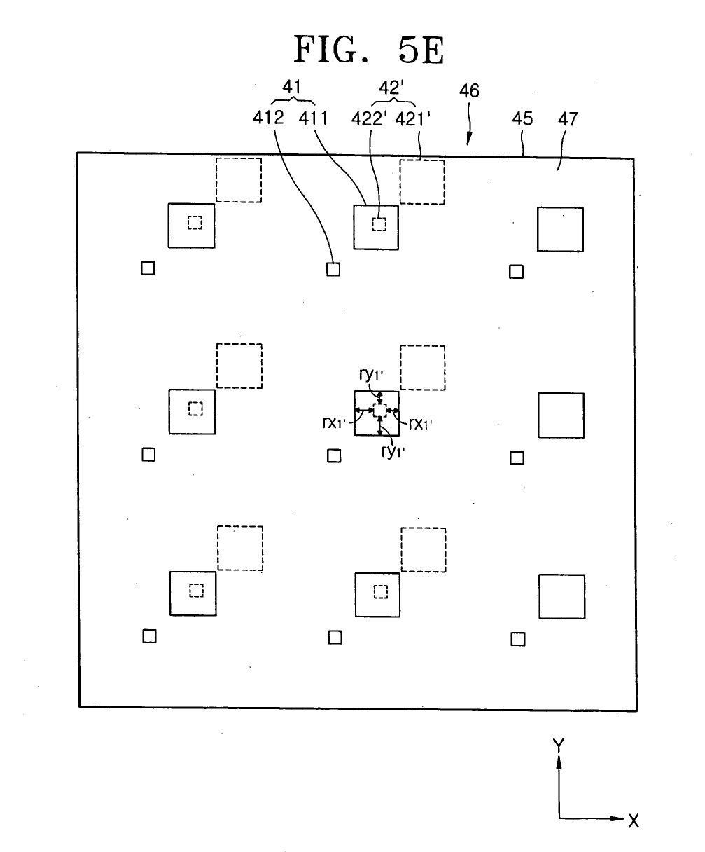

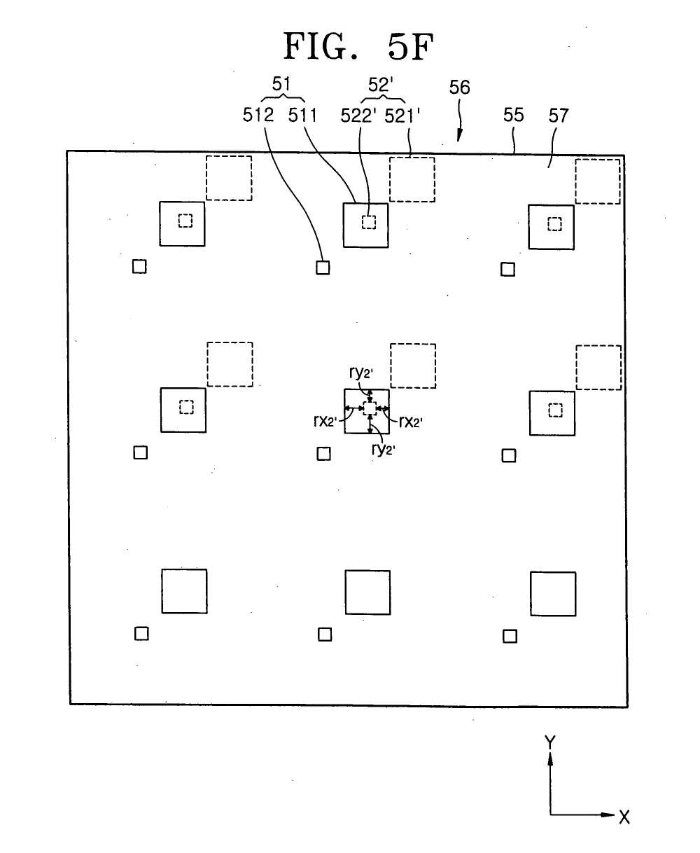

FIG. 4 is a flow chart illustrating a method of measuring the distortion of an exposure apparatus according to an embodiment of the invention. FIGS. 5A through 5F show exemplary exposure patterns on a target wafer further illustrating the method of measuring the distortion according to this embodiment. The exposure patterns of FIGS. 5A through 5F are obtained when the distortion of the exposure apparatus is measured using reticle 30a having measuring patterns 31 shown in FIG. 3A. FIGS. 5A through 5F respectively illustrate a one-shot region exposed using reticle 30a, and further illustrate exposure patterns from a plurality of exposure patterns in the one-shot region. In the illustrated method of measuring the distortion, the distortion of an exposure apparatus may be measured by exposing only two wafers.

Referring to FIGS. 4 and 5A, a first wafer 45 is loaded into the exposure apparatus (S401). Reticle 30a is also loaded into the exposure apparatus (S402). A first photosensitive layer 47 has been previously formed on first wafer 45.

Reticle 30a is then aligned over first wafer 45 (S403). First photosensitive layer 47 is exposed a first time using reticle 30a to form a plurality of first exposure patterns 41 in one-shot region 46 of first wafer 45 (S404). The plurality of first exposure patterns 41 formed in one-shot region 46 correspond to measuring patterns 31 of reticle 30a, and each one of the plurality of first exposure patterns 41 includes a first main scale pattern 411 and a first sub-scale pattern 412 separated by predetermined distances dx1 and dy1 in X and Y directions.

Referring to FIGS. 4 and 5B, first photosensitive layer 47 on first wafer 45 is exposed a second time using reticle 30a to form a plurality of second exposure patterns 42 in one-shot region 46 (S405). Second exposure patterns 42 formed on first wafer 45 correspond to measuring patterns 31 of reticle 30a. Each one of the second exposure patterns 42 includes a second main scale pattern 421 and a second sub-scale pattern 422. Here again second main scale pattern 421 and second sub-scale pattern 422 are separated by predetermined distances dx1 and dy1 in the X and Y directions. The second exposure process is performed after shifting reticle 30a predetermined distances in the X and Y directions, (e.g., a positive X-direction shift (rightward) of (Px1+dx1) and a positive Y-direction shift (upward) of (dy1)). Given this exemplary reticle placement “shift”, each second main scale pattern 421 of second exposure pattern 42 will be kitty-corner to a first main scale pattern 411, and each second sub-scale pattern 422 will be overlay a first main scale pattern 411. In this manner, being but one example of many shifted exposures, the first and second exposure patterns are formed on first wafer 45 with a “shifted relationship”, i.e., any relationship wherein a second exposure of similarly positioned measuring patterns is shifted prior to exposure relative to a first exposure.

In the above description, second exposure pattern 42 is shifted by (+Px1+dx1) in the X direction and by (+dy1) in the Y direction relative to first exposure pattern 41. However, reticle 30a might instead be shifted by (−Px1+dx1) in the X direction and by (+dy1) in the Y direction relative to first exposure pattern 41 to obtain similar results. (See second exposure pattern 42′ shown in FIG. 5E).

Referring now to FIGS. 4 and 5C, first wafer 45 is unloaded (S406), and a second wafer 55 is loaded into the exposure apparatus (S407). A second photosensitive layer 57 has previously been formed on second wafer 55. Reticle 30a is aligned over second wafer 55 (S408), and second photosensitive layer 57 is exposed using reticle 30a to form a plurality of third exposure patterns 51 in one-shot region 56 of second wafer 55 (S409). The plurality of third exposure patterns 51 formed in one-shot region 56 correspond to measuring patterns 31 of reticle 30a, and each one of the plurality of third exposure patterns 51 includes a third main scale pattern 511 and a third sub-scale pattern 512 separated from one another by predetermined distances dx1 and dy1 in the X and Y directions.

Referring to FIGS. 4 and 5D, second photosensitive layer 57 of second wafer 55 is then exposed a second time using reticle 30a to form a plurality of fourth exposure patterns 52 in one-shot region 56 (S410). Each one of the plurality of fourth exposure patterns 52 includes a fourth main scale pattern 521 and a fourth sub-scale pattern 522 separated from one another by predetermined distances dx1 and dy1 in the X and Y directions. However, the second exposure process is performed after shifting reticle 30a by (+dx1) in the X direction and by (−Py1+dy1) in the Y direction relative to the position of the first exposure process.

In the above description, the plurality of fourth exposure patterns 52 are shifted from the position of the plurality of third exposure patterns 51 by (+dx1) in the X direction and by (−Py1+dy1) in Y direction. However, referring to FIG. 5F, reticle 30a might alternatively be shifted by (+dx1) in the X direction and by (+Py1+dy1) in the Y direction relative to the first exposure process to similarly form the plurality of fourth exposure patterns 52′, where each one of the plurality of fourth exposure pattern 52′ includes a fourth main scale pattern 521′ and a fourth sub-scale pattern 522′ separated from each other by predetermined distances dx1 and dy1 in the X and Y directions.

Referring to FIGS. 4, 5B, and 5D again, second wafer 45 is unloaded (S411), and first photosensitive layer 47 of first wafer 45 and second photosensitive layer 57 of second wafer 55 are developed using a conventional developing process (S412). An overlay between first exposure patterns 41 and second exposure patterns 42 formed on first wafer 45 is measured using an overlay measurement apparatus (not shown) to measure the overlay accuracy in the X direction (S413). In addition, an overlay between third exposure patterns 51 and fourth exposure patterns 52 formed on second wafer 55 is measured using the overlay measuring apparatus to measure the overlay accuracy in the Y direction (S414).

In this manner, the overlay measurement apparatus measures relative errors (rx1 and ry1) between the second sub-scale pattern 422 of second exposure pattern 42 and the first main scale pattern 411 of first exposure pattern 41 to obtain an indication of overlay accuracy in the X direction. In addition, the overlay measuring apparatus measures relative errors (rx2 and ry2) between the fourth sub-scale pattern 522 of fourth exposure pattern 52 and the third main scale pattern 511 of third exposure pattern 51 to obtain an indication of the of overlay accuracy in the Y direction. The relative errors rx1 and ry1 are deviations between second exposure pattern 42 and first exposure pattern 41, as formed through shifted reticle 30a once. The relative errors rx2 and ry2 are deviations between fourth exposure patterns 52 and third exposure patterns 51, as formed through shifted reticle 30a.

Referring to the illustrated example shown in FIG. 5B, relative error rx1 is a distance measured between first main scale pattern 411 of first exposure pattern 41 and second sub-scale pattern 422 of second exposure pattern 42 in the X direction. Relative error ry1 is a distance measured between first main scale pattern 411 of first exposure pattern 41 and second sub-scale pattern 422 of second exposure pattern 42 in the Y direction.

Referring to FIG. 5D, relative error rx2 is a distance measured between third main scale pattern 511 of third exposure pattern 51 and fourth sub-scale pattern 522 of fourth exposure pattern 52 in the X direction. Relative error ry2 is a distance measured between third main scale pattern 511 of third exposure pattern 51 and fourth sub-scale pattern 522 of fourth exposure pattern 52 in the Y direction.

With reference to FIG. 3A, the distance (Px1) between neighboring measuring patterns 31 in the X direction will typically be in the range of a few millimeters. The distance (dx1) between a main scale 311 and an associated (e.g., closest) sub-scale 312 of the measuring pattern 31 in the X direction will typically be in the range of a few hundred micrometers. Thus, the shift magnitudes, e.g., (+Px1+dx1) and (−Px1+dx1) may be readily approximated to about (Px1). In addition, the distance (dy1) between a main scale 311 and an associated sub-scale 312 in the Y direction will also typically be in a range of a few hundred micrometers, and may thus be approximated to 0 relative to Px1 and Py1. Therefore, second exposure patterns 42 may be said to be shifted by first pitch Px1 in the X direction and by zero in the Y direction relative to the position of first exposure patterns 41, or a shift magnitude of approximately (Px1, 0).

In similar fashion and assuming similar separation distances in the Y direction, fourth exposure patterns 52 may be said to be shifted by second pitch Py1 in the Y direction and by zero in the X direction relative to the position of third exposure pattern 51, or a shift magnitude of approximately (0, Py1).

In addition, the distortion generated by the exposure apparatus may be obtained from relative errors rx1 and ry1 when reticle 30a is shifted in the X direction and relative errors rx2 and ry2 when the reticle 30a is shifted in the Y direction (S415). Second exposure patterns 42 are obtained by shifting first exposure patterns 41 by (Px1, 0), and thus, relative errors rx1 and ry1 can be represented by the following equation.

$$( rx 1 , ry 1 ) = ( u 1 ( x + px , y ) , v 1 ( x + px , y ) ) - ( u ( x ) , v ( y ) ) ≅ ( \frac{ⅆ u 1}{ⅆ y} ( x , y ) , \frac{ⅆ v 1}{ⅆ y} ( x , y ) ) \cdot Px 1 \qquad ( 1 )$$

From Equation (1), the value of du1/dy, dv1/dy can be calculated since relative errors rx1 and ry1, and the value of first pitch Px1 are known.

In addition, fourth exposure patterns 52 are obtained by shifting the third exposure patterns 51 by (0, Py1), and thus, relative errors rx2 and ry2 can be represented by the following equation.

$$( rx 2 , ry 2 ) = ( u 2 ( x , y ) + py , v 2 ( x , y + py ) ) - ( u ( x ) , v ( y ) ) ≅ ( \frac{ⅆ u 2}{ⅆ y} ( x , y ) , \frac{ⅆ v 2}{ⅆ y} ( x , y ) ) \cdot Py 1 \qquad ( 2 )$$

From Equation (2), the value of du2/dy, dv2/dy can be calculated since the relative errors rx2 and ry2, and the value of second pitch Py1 are known.

Therefore, the values of du1/dy, dv1/dy in the X direction with respect to first and second exposure patterns 41 and 42 formed in one-shot region 46 which correspond to measuring patterns 31 of reticle 30a can be calculated, and the values of du2/dy, dv2/dy in the Y direction with respect to third and fourth exposure patterns 51 and 52 formed in one-shot region 56 which correspond to measuring patterns 31 of reticle 30a can be calculated. Therefore, distortion in the X direction (u1 and v1) and distortion in the Y direction (u2 and v2) can be calculated using the following linear partial differential equation.

$$\frac{ⅆ u 1}{ⅆ y} = rx 1 , \frac{ⅆ v 1}{ⅆ y} = rx 2 \\ \frac{ⅆ u 2}{ⅆ y} = ry 1 , \frac{ⅆ v 2}{ⅆ y} = ry 2 \qquad ( 3 )$$

The distortion of the exposure apparatus with respect to an absolute grid of the exposure apparatus can be calculated from u(x, y) and v(x, y) obtained using Equations (3). The absolute grid denotes an ideal grid for the exposure apparatus itself. Therefore, instead of using the conventional method, in which an orthogonal grid is formed on the wafer as a standard grid and relative distortion of the exposure apparatus with respect to the orthogonal grid is measured, two wafers are twice exposed to form relative exposure patterns by shifting reticle 30a between the respective exposure processes in relation to pitches defining separation distances between measuring patterns in the X and Y directions. This approach does not require formation of the orthogonal grid on a target wafer, and thus, distortion associated with the exposure apparatus with respect to an absolute grid may be accurately measured. As a result, absolute distortion values for the exposure apparatus can be rapidly and accurately measured for the exposure apparatus.

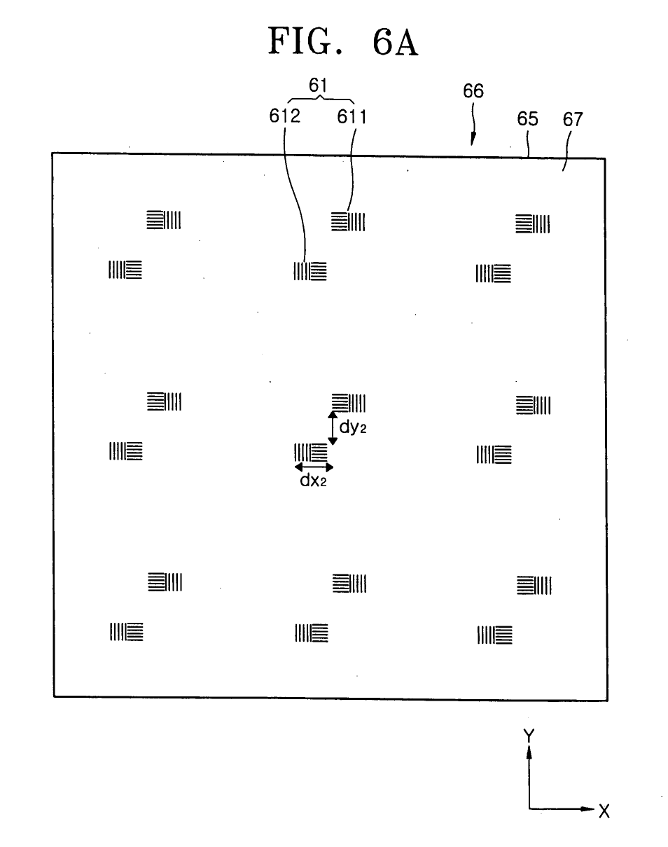

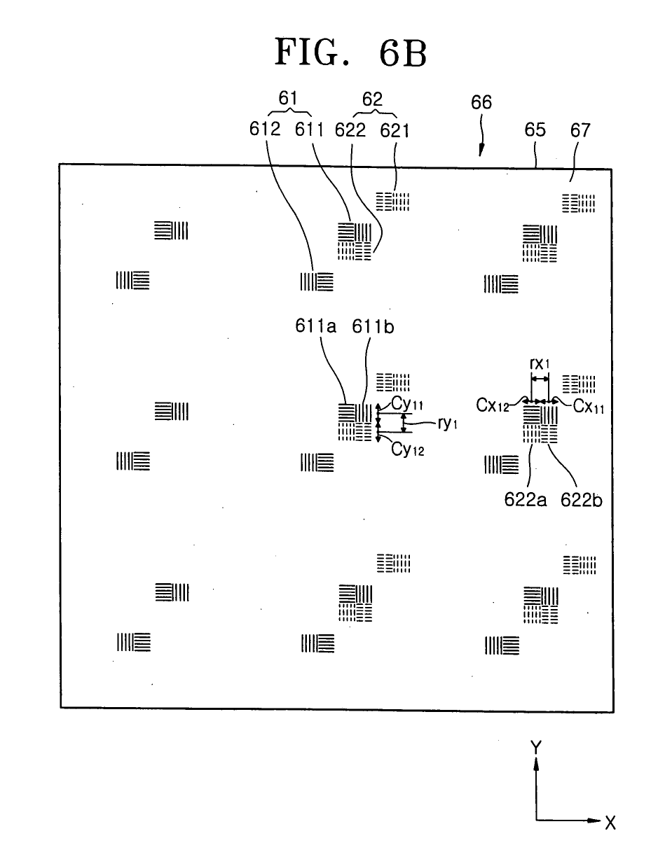

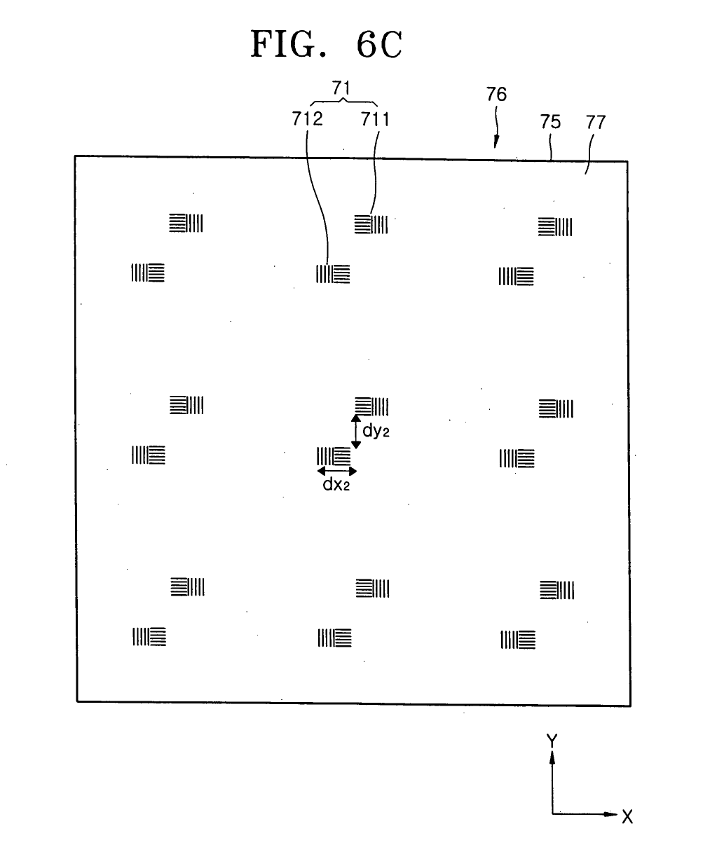

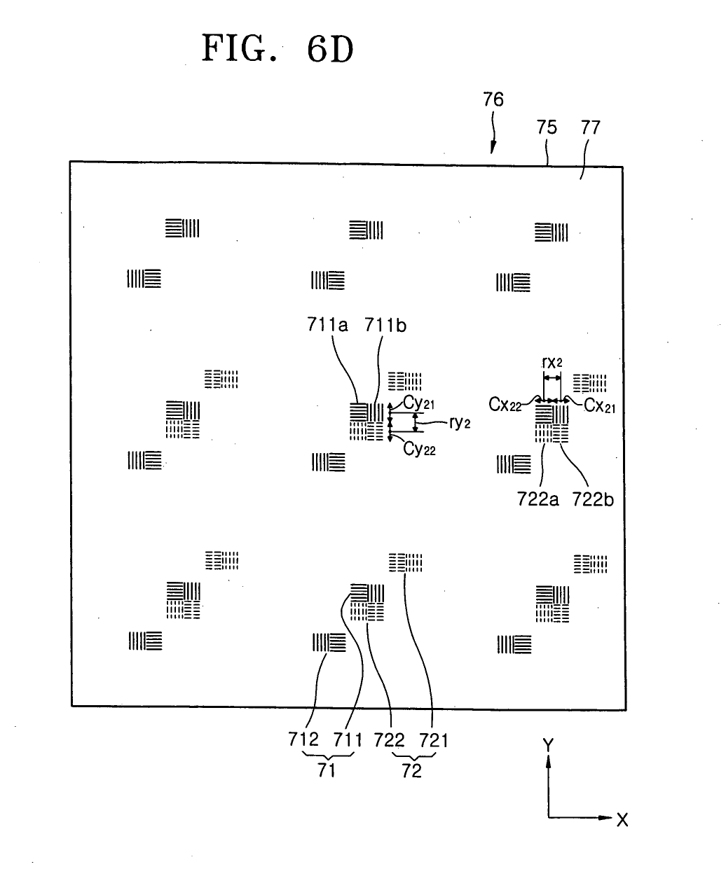

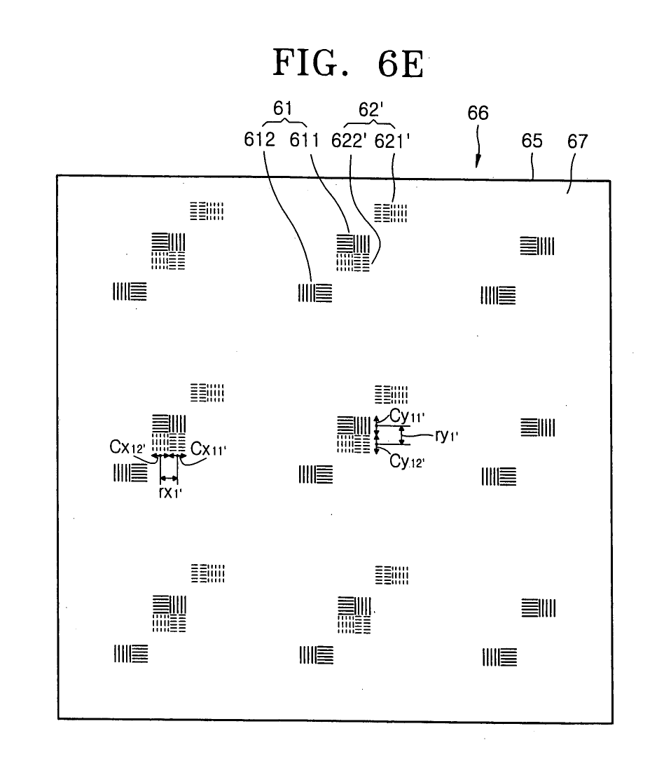

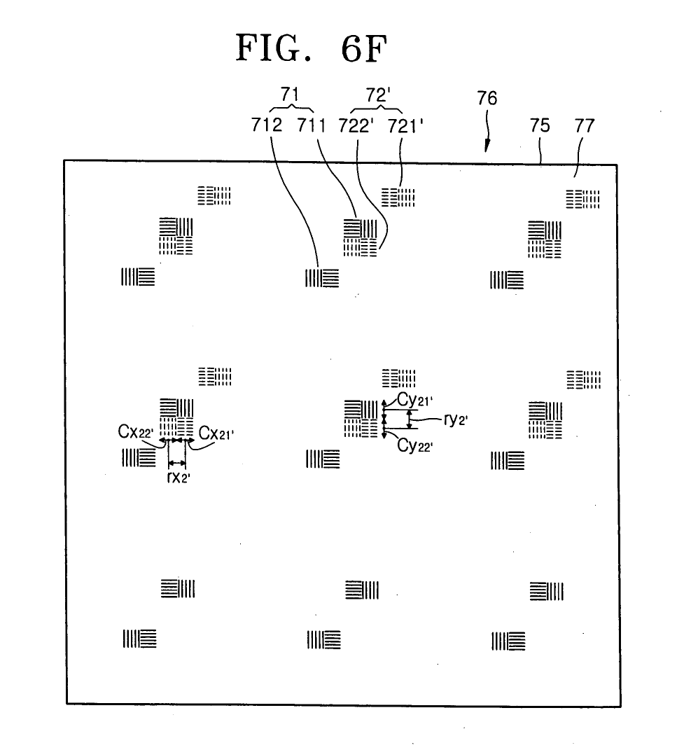

FIGS. 6A through 6F are views of exposure patterns of a wafer for illustrating the method of measuring the distortion of the exposure apparatus shown in FIG. 4 using reticle 30b including measuring patterns 32 of FIG. 3B. FIGS. 6A through 6F respectively illustrate some exposure patterns arranged in a one-shot region. The distortion measured using the exposure patterns of FIGS. 6A through 6F is measured in the same manner as that described with reference to the method of FIG. 4 and FIGS. 5A through 5F, and thus, a more detailed description will be omitted.

FIG. 6A illustrates first exposure patterns 61 formed in a one-shot region 66 by initially exposing a first photosensitive layer 67 on a first wafer 65 using reticle 30b of FIG. 3B (S404). A plurality of first exposure patterns 61 formed in one-shot region 66 corresponds to measuring patterns 32 of reticle 30b. Each one of the plurality of first exposure patterns 61 includes a first main scale pattern 611 and a first sub-scale pattern 612 separated by predetermined distances dx2 and dy2 in X and Y directions, respectively. FIG. 6B illustrates second exposure patterns 62 formed in one-shot region 66 by subsequently exposing first photosensitive layer 67 of first wafer using reticle 30b of FIG. 3B (S405). A plurality of second exposure patterns 62 are formed in one-shot region 66 corresponds to measuring patterns 32 of reticle 30b. Each one of the plurality of second exposure patterns 62 includes a second main scale pattern 621 and a second sub-scale pattern 622 separated from each other by predetermined distances dx2 and dy2 in the X and Y directions, respectively.

As before, the second exposure is performed after shifting reticle 30b by a predetermined distance, (e.g., (+Px2+dx2) in the X direction, and (+dy2) in the Y direction, relative to the first exposure process. As before, second sub-scale pattern 622 of second exposure pattern 62 is overlaid on first main scale pattern 611 of first exposure pattern 61.

Again with reference to FIG. 3B, the distance (Px2) between neighboring measuring patterns 32 of reticle 30b in the X direction, is typically measured in a range of a few millimeters. The distance (dx2) between main scale pattern 321 and an associated sub-scale pattern 322 is typically measured in a range of a few hundred micrometers. Thus, the magnitude (+Px2+dx2) may be approximated to (Px2). In addition, the distance (dy2) between main scale pattern 321 and sub-scale pattern 322 in the Y direction is also typically measured a range of a few hundred micrometers, and may thus be approximated to 0. Therefore, second exposure patterns 62 are shifted relative to first exposure patterns 61 by a magnitude of approximately (Px2, 0).

Referring now to FIG. 6B, relative errors rx1 and ry1 between second sub-scale pattern 622 of second exposure pattern 62 and first main scale pattern 611 of first exposure pattern 61 are measured using the same process described above relative to exemplary method step (S413) in order to measure an overlay in the X direction. Relative error rx1 is a distance between a center (Cx11) of a lined pattern 611b of first main scale pattern 611 arranged in X direction and a center (Cx12) of a lined pattern 622a of second sub-scale pattern 622 arranged in the X direction. In addition, relative error ry1 is a distance between a center (Cy11) of a lined pattern 611a of first main scale pattern 611 arranged in the Y direction and a center (Cy12) of a lined pattern 622b of second sub-scale pattern 622 arranged in the Y direction.

Alternatively, the second exposure process may be performed after shifting reticle 30b by (−Px2+dx2) in the X direction and (+dy2) in the Y direction, relative to the position of the first exposure to form second exposure patterns 62′ as shown in FIG. 6E. In this case, second sub-scale pattern 622′ of second exposure pattern 62′ is similarly overlaid on first main scale pattern 611 of first exposure pattern 61.

FIG. 6C illustrates third exposure patterns 71 formed in one-shot region 76 by initially exposing a second photosensitive layer 77 on a second wafer 75 using reticle 30b of FIG. 3B (S409). A plurality of third exposure patterns 71 formed in one-shot region 76 correspond to measuring patterns 32 of reticle 30b. Each one of the plurality third exposure patterns 71 includes a third main scale pattern 711 and a third sub-scale pattern 712 separated from each other by predetermined distances dx2 and dy2 in the X and Y directions. FIG. 6D illustrates fourth exposure patterns 72 formed in one-shot region 76 by subsequently exposing second photosensitive layer 77 on second wafer 75. A plurality of fourth exposure patterns 72 formed in one-shot region 76 correspond to measuring patterns 32 of reticle 30b. Each one of the plurality of fourth exposure patterns 72 includes a fourth main scale pattern 721 and a fourth sub-scale pattern 722 separated from each other by predetermined distances dx2 and dy2 in the X and Y directions.

The second exposure is performed after shifting reticle 30b by (+dx2) in the X direction and by (−Py2+dy2) in the Y direction, relative to the position of the first exposure. In this manner, as before, fourth sub-scale pattern 722 of fourth exposure pattern 72 is overlaid on third main scale pattern 711 of third exposure pattern 71.

The distance (Py2) between neighboring measuring patterns 32 of reticle 30b in the Y direction is typically measured in a range of few millimeters, and the distance (dy2) between main scale 321 and an associated sub-scale 322 is typically measured in a range of a few hundred micrometers. Thus, the magnitude of (−Py2+dy2) may be approximated to −Py2. In addition, the distance (dx2) between main scale 321 and an associated sub-scale 322 the X direction is typically measured in a range of a few hundred micrometers. Thus, dx2 may be approximated to 0. Therefore, fourth exposure patterns 62 are shifted relative to third exposure patterns 71 by a magnitude of approximately (0, Py2).

Therefore, referring to FIG. 6D, relative errors rx2 and ry2 between fourth sub-scale pattern 722 of fourth exposure pattern 72 and third main scale pattern 711 of third exposure pattern 71 define an overlay in the Y direction (S414). Relative error rx2 is a distance measured between a center (Cx21) of a lined pattern 711b of third main scale pattern 711 arranged in the X direction and a center (Cx22) of a lined pattern 722a of fourth sub-scale pattern 722 arranged in the X direction. In addition, relative error ry2 is a distance measured between a center (Cy21) of a lined pattern 711a of third main scale pattern 711 arranged in the Y direction and a center (Cy22) of a lined pattern 722b of fourth sub-scale pattern 722 arranged in the Y direction.

Alternatively, before the second exposure process, reticle 30b may be shifted by (+dx2) in the X direction and (+Py2+dy2) in the Y direction, relative to the position of the first exposure process to form fourth exposure patterns 72′ as shown in FIG. 6F. In a similar manner to the foregoing, fourth sub-scale pattern 722′ of fourth exposure pattern 72′ is thus overlaid on third main scale pattern 711 of third exposure pattern 71.

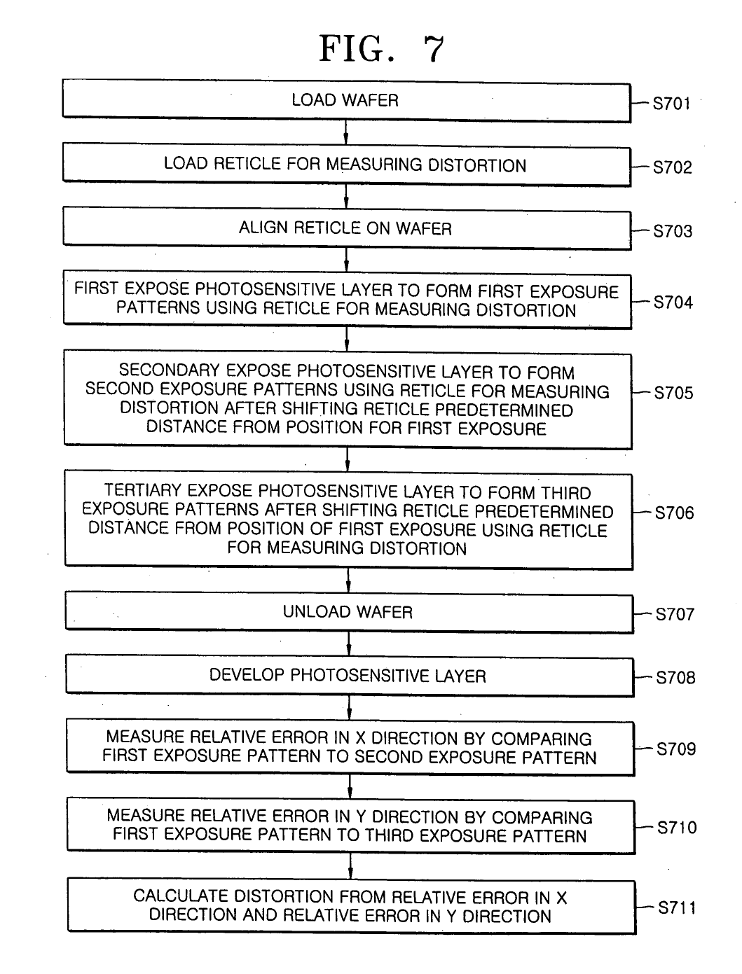

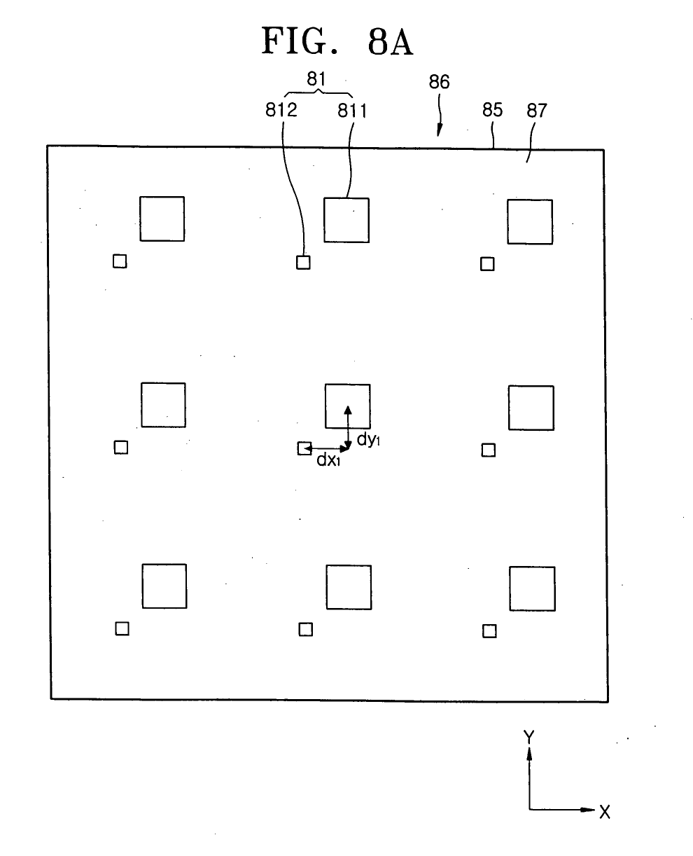

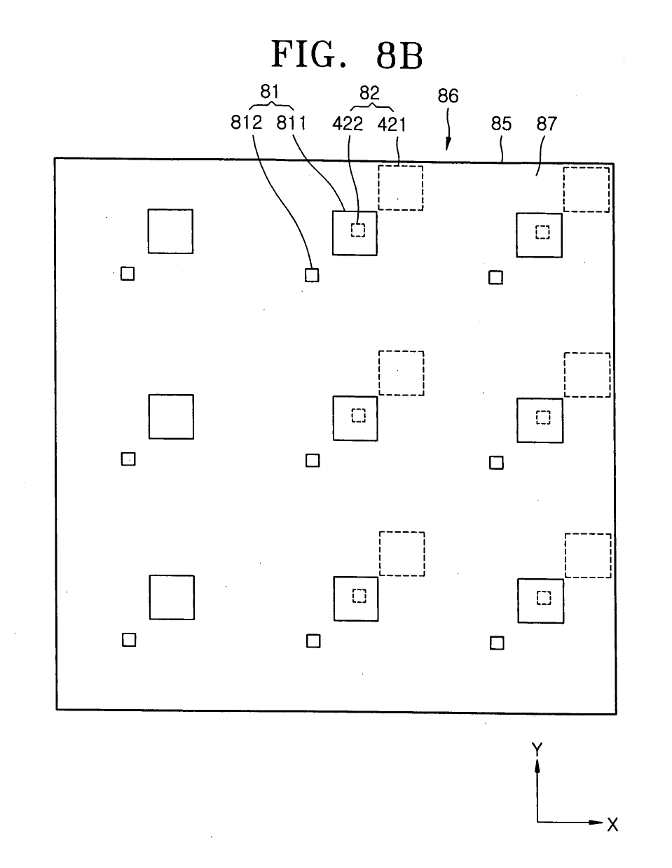

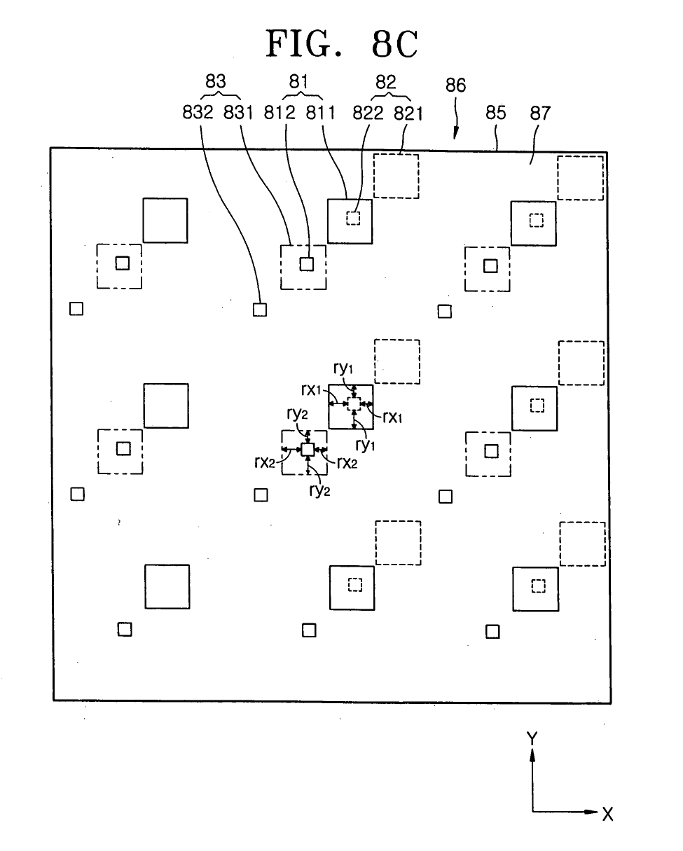

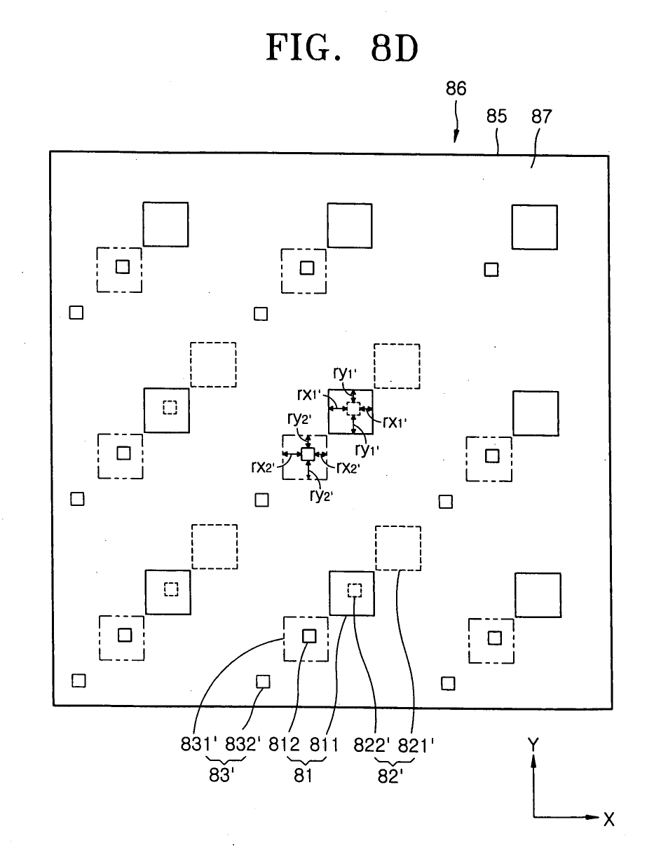

FIG. 7 is a flow chart illustrating a method of measuring distortion for an exposure apparatus according to another embodiment of the invention. FIGS. 8A through 8D illustrate exemplary exposure patterns for a target wafer and further illustrate the method of this embodiment. The exposure patterns of FIGS. 8A through 8D are obtained when the distortion of the exposure apparatus is measured using reticle 30a having measuring patterns 31, as shown in FIG. 3A. FIGS. 8A through 8D respectively illustrate exposure patterns in a one-shot region.

Referring to FIGS. 7 and 8A, a wafer 85 is loaded in the exposure apparatus (S701), and reticle 30a is loaded in the exposure apparatus (S702). A photosensitive layer 87 has been previously formed on wafer 85. Reticle 30a is aligned over wafer 85 (S703). Photosensitive layer 87 is exposed using reticle 30a to form a plurality of first exposure patterns 81 in one-shot region 86 of wafer 85 (S704). The plurality of first exposure patterns 81 formed in one-shot region 86 correspond to measuring patterns 31 of reticle 30a. Each one of the plurality of first exposure patterns 81 includes a first main scale pattern 811 and a first sub-scale pattern 812 separated from each other by predetermined distances dx1 and dy1 in X and Y directions.

Referring to FIGS. 7 and 8B, photosensitive layer 87 of wafer 85 is exposed a second time using reticle 30a to form a plurality of second exposure patterns 82 in one-shot region 86 (S705). Second exposure patterns 82 formed in one-shot region 86 of wafer 85 correspond to measuring patterns 31 of reticle 30a. Each one of the plurality of second exposure patterns 82 includes a second main scale pattern 821 and a second sub-scale pattern 822 separated from each other by predetermined distances dx1 and dy1 in the X and Y directions. The second exposure is performed after shifting reticle 30a a predetermined distance (e.g., by (+Px1+dx1) in the X direction and by (+dy1) in the Y direction). In this manner as before, second sub-scale pattern 822 of second exposure pattern 82 is overlaid on first main scale pattern 811 of first exposure pattern 81.

In the above description, second exposure pattern 82 is shifted by (+Px1+dx1) in the X direction and by (+dy1) in the Y direction from first exposure pattern 81. However, reticle 30a might alternatively be shifted by (−Px1+dx1) in the X direction and by (+dy1) in the Y direction relative to the position of first exposure 81 to form second exposure patterns 82′ as shown in FIG. 8D, whereby second sub-scale pattern 822′ of second exposure pattern 82′ is overlaid on first main scale pattern 811 of first exposure pattern 81.

Referring to FIGS. 7 and 8C, reticle 30a is aligned over wafer 85 after performing the second exposure process and photosensitive layer 87 is exposed a third time to form a plurality of third exposure patterns 83 (S706). Third exposure patterns 83 formed in one-shot region 86 correspond to measuring patterns 31 of reticle 30a. Each one of the plurality of third exposure patterns 83 includes a third main scale pattern 831 and a third sub-scale pattern 832 separated by predetermined distances dx1 and dy1 in the X and Y directions. The third exposure process is performed after shifting reticle 30a (e.g., by −dx1 in the X direction, and by (+Py1−dy1) in the Y direction), relative to the position of the first exposure, whereby third main scale pattern 831 of third exposure pattern 83 is overlaid on first sub-scale pattern 812 of first exposure pattern 81.

In the above description, third exposure pattern 83 is shifted by (−dx1) in the X direction and by (+Py1−dy1) in the Y direction, relative to first exposure pattern 81. Alternatively, reticle 30a might be shifted by (−dx1) in the X direction and by (−Py1−dy1) in the Y direction, relative to the position of the third exposure process to form third exposure patterns 83′ as shown in FIG. 8D. Thus, in similar manner, third main scale pattern 832′ of third exposure pattern 83′ is overlaid on first sub-scale pattern 811 of first exposure pattern 81.

Referring to FIGS. 7 and 8C, wafer 85 is unloaded (S707), and photosensitive layer 87 of wafer 85 is developed (S708). The overlay between first exposure pattern 81 and second exposure pattern 82 is measured using an overlay measurement apparatus (not shown) to measure the overlay accuracy in the X direction (S709), and the overlay between first exposure pattern 81 and third exposure pattern 83 is measured to measure the overlay accuracy in the Y direction (S710). Therefore, the overlay measurement apparatus measures relative errors rx1 and ry1 between second sub-scale pattern 822 of second exposure pattern 82 and first main scale pattern 811 of first exposure pattern 81, and relative errors rx2 and ry2 between third main scale pattern 831 of third exposure pattern 83 and first sub-scale pattern 812 of first exposure pattern 81. Relative errors rx1 and ry1 are deviations measured between second exposure patterns 82 and first exposure patterns 81 when reticle 30a is shifted in the X direction, and relative errors rx2 and ry2 are deviations measured between third exposure patterns 83 and first exposure patterns when reticle 30a is shifted in the Y direction.

The distance (Px1) between neighboring measuring patterns 31 of reticle 30a in the X direction is typically in the range of a few millimeters, and the distance (dx1) between main scale 311 and an associated sub-scale 312 of measuring pattern 31 is in the range of a few hundred micrometers. Thus, the magnitudes (+Px1+dx1) and (−Px1+dx1) may each be approximated to (Px1). In addition, the distance (dy1) between main scale 311 and sub-scale 312 of measuring pattern 31 in the Y direction is also in the range of a few hundred micrometers, and may thus be approximated to 0. Therefore, second exposure patterns 82 are shifted relative to the position of first exposure patterns 81 by a magnitude of approximately (Px1, 0).

In addition, the distance (Py1) between neighboring measuring patterns 31 of reticle 30a in the Y direction is typically in the range of a few millimeters, and the distance (dy1) between main scale 311 and an associated sub-scale 312 of measuring pattern 31 is typically in the range of a few hundred micrometers. Thus, magnitudes (+Py1−dy1) and (−Py1−dy1) may be approximated to (Py1). The distance (dx1) between main scale 311 and sub-scale 312 of measuring pattern 31 in the X direction is typically in the range of a few hundred micrometers, and may thus be approximated to 0. Therefore, third exposure patterns 83 are shifted relative to the position of first exposure patterns 81 by a magnitude of approximately 0, Py1).

The distortion generated by the exposure apparatus may be obtained from relative errors rx1 and ry1 obtained by shifting reticle 30a in the X direction and relative errors rx2 and ry2 obtained by shifting reticle 30a in the Y direction (S711). Second exposure patterns 82 are obtained by shifting the first exposure patterns 41 by (Px1, 0), and thus, relative errors rx1 and ry1 may be represented by Equation (1) above. From Equation (1), the values of du1/dy and dv1/dy can be calculated since the relative errors rx1 and ry1, and the first pitch Px1 are known. In addition, third exposure patterns 83 are obtained by shifting first exposure patterns 81 by (0, Py1), and thus, relative error rx2 and ry2 can be represented by Equation (2) above. From Equation (2), the values of du2/dy and dv2/dy can be calculated since the relative errors rx2 and ry2, and the second pitch Py1 are known.

Therefore, the values of du1/dy, dv1/dy in the X direction with respect to first and second exposure patterns 81 and 82 formed in one-shot region 86 can be calculated, and the values of du2/dy, dv2/dy in the Y direction with respect to first and third exposure patterns 81 and 83 formed in one-shot region 86 can be calculated. Therefore, distortion in the X direction (u1 and v1) and distortion in the Y direction (u2 and v2) can be calculated using the above Equation (3).

The distortion of the exposure apparatus with respect to an absolute grid of the exposure apparatus can be calculated from u(x, y) and v(x, y) obtained using the above Equation (3). The absolute grid denotes a grid of the exposure apparatus itself. Therefore, instead of using the conventional method in which an orthogonal grid is formed on the wafer as a standard grid and the relative distortion of the exposure apparatus with respect to the orthogonal grid is measured, a wafer is exposed three times to form the exposure patterns after moving the reticle 30a between exposure processes by the pitches of the measuring patterns in the X and Y directions without forming the orthogonal grid on the wafer, and thus, the distortion of the exposure apparatus with respect to the absolute grid is measured. Therefore, the absolute distortion values of the exposure apparatus can be measured rapidly with the exposure apparatus.

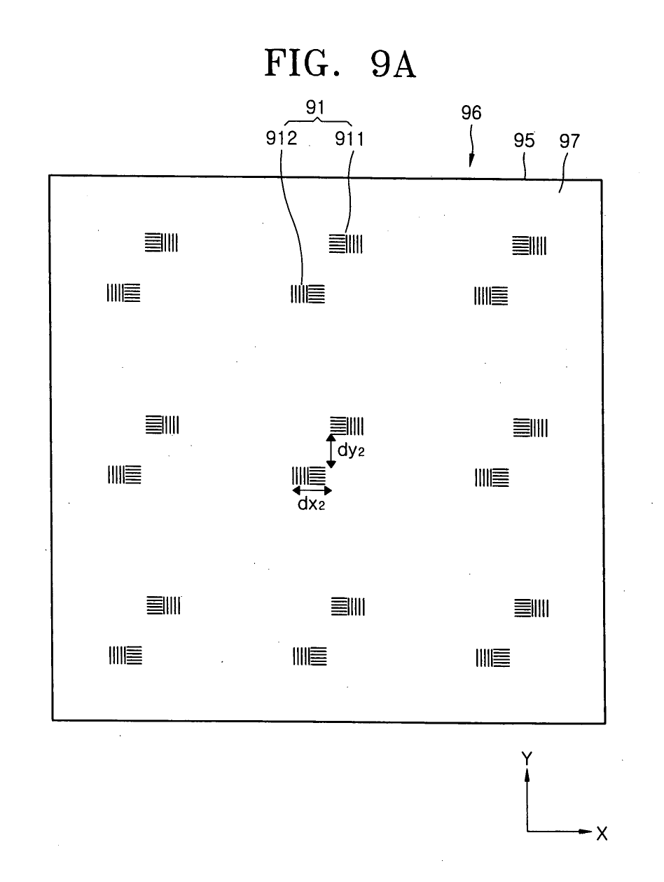

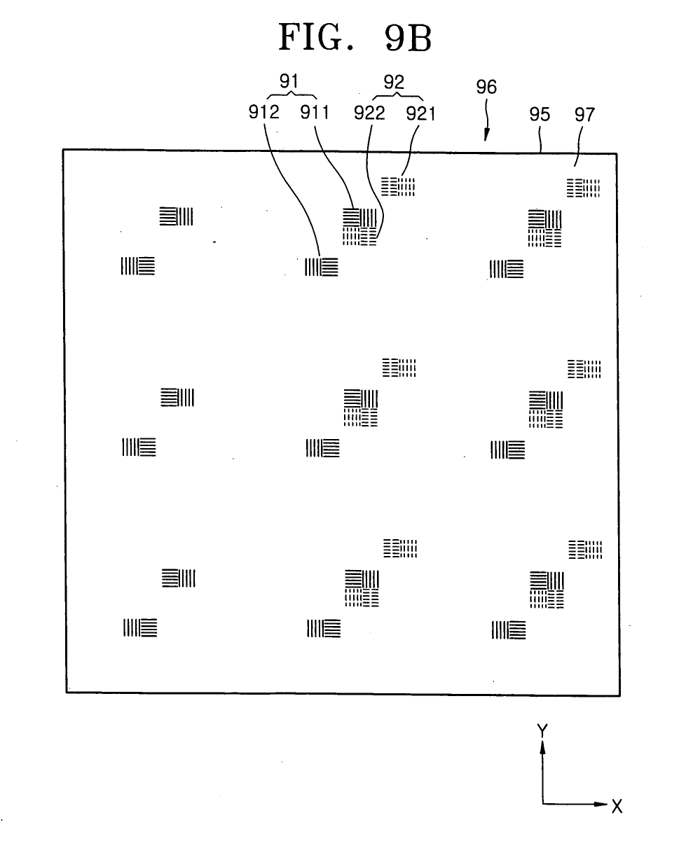

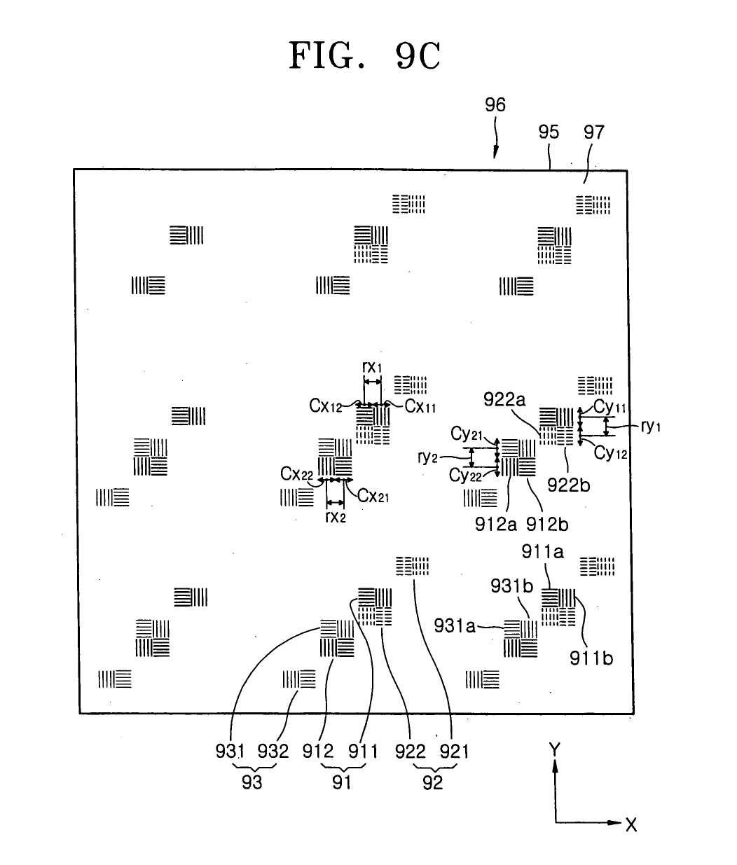

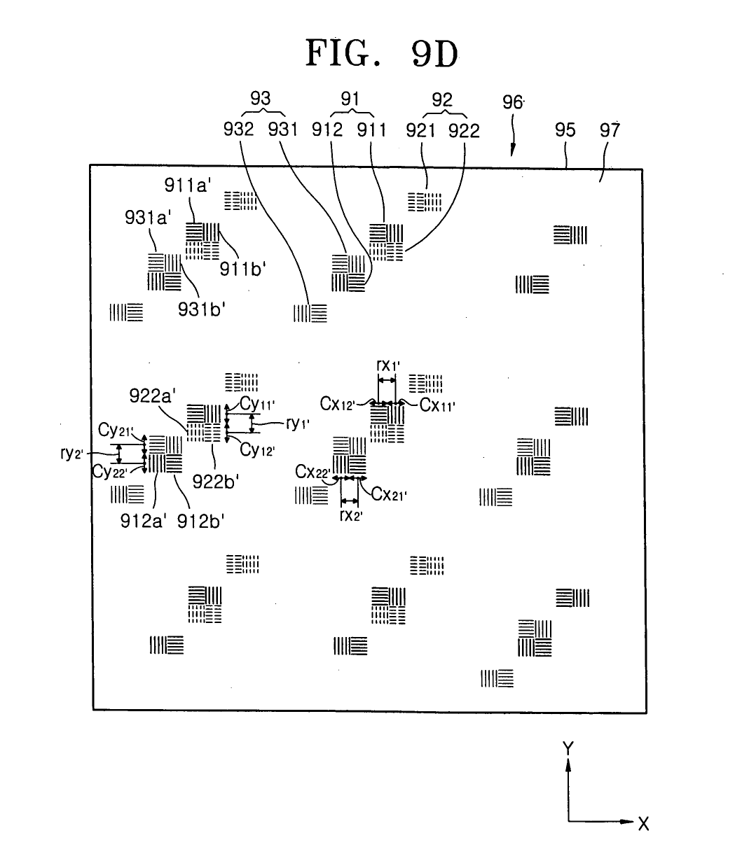

FIGS. 9A through 9D are views of exposure patterns on a target wafer and further illustrate the method of measuring distortion for an exposure apparatus shown in FIG. 7 using reticle 30b including measuring patterns 32 of FIG. 3B. FIGS. 9A through 9D respectively illustrate exposure patterns arranged in a one-shot region. The distortion measured using the exposure patterns of FIGS. 9A through 9D is measured in the same way as described with reference to FIGS. 8A through 8D, and thus, detailed descriptions for measuring the distortion according to the processes of FIG. 7 will be omitted.

FIG. 9A illustrates first exposure patterns 91 initially formed in a one-shot region 96 by exposing a first photosensitive layer 97 on a wafer 95 using reticle 30b of FIG. 3B (S704). A plurality of first exposure patterns 91 formed in one-shot region 96 correspond to measuring patterns 32 of reticle 30b. Each one of the plurality of first exposure patterns 91 includes a first main scale pattern 911 and a first sub-scale pattern 912 separated by predetermined distances dx2 and dy2 in X and Y directions. FIG. 9B illustrates second exposure patterns 92 formed in one-shot region 96 by subsequently exposing photosensitive layer 97 of wafer 95 using reticle 30b of FIG. 3B in a second exposure process (S705). A plurality of second exposure patterns 92 are formed in one-shot region 96 that correspond to measuring patterns 32 of reticle 30b. Each one of the plurality of second exposure patterns 92 includes a second main scale pattern 921 and a second sub-scale pattern 922. In addition, second main scale pattern 921 and second sub-scale pattern 922 are separated by predetermined distances dx2 and dy2 in the X and Y directions.

The second exposure is performed after shifting reticle 30b by a predetermined distance (e.g., by (+Px2+dx2) in the X direction and by (+dy2) in the Y direction), relative to the position at which the first exposure process was performed and aligning reticle 30b over first wafer 65. Thus, second sub-scale pattern 922 of second exposure pattern 92 is overlaid on first main scale pattern 911 of first exposure pattern 91.

Alternatively, the second exposure process may be performed after shifting reticle 30b by (−Px2+dx2) in the X direction and (+dy2) in the Y direction relative to the first exposure to form second exposure patterns 92′ as shown in FIG. 9D. Similar to the foregoing, second sub-scale pattern 922′ of second exposure pattern 92′ is overlaid on first main scale pattern 911 of first exposure pattern 91.

Approximations of these separation distances may be made, as above, such that second exposure patterns 92 and 92′ are shifted relative to the position of first exposure patterns 91 by a magnitude of approximately (Px2, 0).

FIG. 9C illustrates third exposure patterns 93 formed in one-shot region 96 by exposing photosensitive layer 97 on wafer 95 a third time using reticle 30b of FIG. 3B (S707). A plurality of third exposure patterns 93 formed in one-shot region 96 correspond to measuring patterns 32 of reticle 30b. Each one of the plurality of third exposure patterns 93 includes a third main scale pattern 931 and a third sub-scale pattern 932 separated by predetermined distances dx2 and dy2 in X and Y directions.

The third exposure is performed after shifting reticle 30b by a predetermined distance of −dx2 in the X direction and (+Py2−dy2) in the Y direction, from the position where the first exposure was performed, and aligning reticle 30b over first wafer 95. By this shift, third main scale pattern 931 of third exposure pattern 93 is overlaid on first sub scale pattern 912 of first exposure pattern 91.

Alternatively, the third exposure process may be performed after shifting reticle 30b by (−dx2) in the X direction and by (−Py2−dy2) in the Y direction from the position where the first exposure was performed to form third exposure patterns 93′ as shown in FIG. 9D. In this manner, third main scale pattern 931′ of third exposure pattern 93′ is overlaid on first sub scale pattern 912 of first exposure pattern 91.

Here again, the separation distances between third exposure patterns 93 and 93′ and first exposure patterns 91 may be approximated by magnitude (0, Py2).

Referring to FIG. 9C, relative errors rx1 and ry1 between second sub-scale pattern 922 of second exposure pattern 92 and first main scale pattern 911 of first exposure pattern 91 are measured in the X direction (S709). Relative error rx1 is the distance between a center (Cx11) of a lined pattern 911b of first main scale pattern 911 arranged in X direction and a center (Cx12) of a lined pattern 922a of second sub-scale pattern 922 arranged in the X direction. In addition, the relative error ry1 is the distance between center (Cy11) of a lined pattern 911a of first main scale pattern 911 arranged in Y direction and center (Cy12) of a lined pattern 922b of second sub-scale pattern 922 arranged in the Y direction.

In addition, referring to FIG. 9C, relative errors rx2 and ry2 between third main scale pattern 931 of third exposure pattern 93 and first sub-scale pattern 912 of first exposure pattern 91 are measured in the Y direction (S710). The relative error rx2 is the distance between a center (Cx21) of a lined pattern 931b of third main scale pattern 931 arranged in X direction and a center (Cx22) of a lined pattern 912a of first sub-scale pattern 912 arranged in the X direction. In addition, relative error ry2 is the distance between center (Cy21) of a lined pattern 931a of third main scale pattern 931 arranged in Y direction and center (Cy22) of a lined pattern 912b of first sub-scale pattern 912 arranged in the Y direction.

According to the illustrated embodiments of the invention, the second exposure and third exposure of the first exposed wafer are performed after shifting the reticle by the first pitch in the X direction or the second pitch in the Y direction. However, the reticle shift may be controlled in other ways.

As described above, the wafer is exposed two or three times to form exposure patterns while moving the reticle in the X and Y directions in relation to one or more pitches between measuring patterns of the reticle. This approach allows distortion to be accurately measured without forming an orthogonal grid on the wafer, but rather distortion for an exposure apparatus may be determined with respect to an absolute grid. Therefore, the absolute value of the distortion of the exposure apparatus can be rapidly measured through direct operation of the exposure apparatus, and the difference between measured distortion and an ideal grid may be readily determined.

While the present invention has been particularly shown and described with reference to exemplary embodiments thereof, it will be understood by those of ordinary skill in the art that various changes in form and details may be made therein without departing from the scope of the invention as defined by the following claims.

What is claimed is:

1. A method of measuring distortion for an exposure apparatus, the method comprising:
aligning a reticle comprising a plurality of measuring patterns over a first wafer, wherein the plurality of measuring patterns are separated by a first pitch in a first direction and a second pitch in a second direction orthogonal to the first direction;
forming a plurality of first exposure patterns on the first wafer by performing a first exposure process through the reticle;
shifting the reticle by a first distance from a position at which the first exposure process was performed and aligning the reticle over the first wafer;
forming a plurality of second exposure patterns on the first wafer by performing a second exposure process through the reticle;
aligning the reticle over a second wafer;
forming a plurality of third exposure patterns on the second wafer by performing a third exposure process though the reticle;
shifting the reticle by a second distance from a position where the third exposure process was performed and aligning the reticle over the second wafer;
forming a plurality of fourth exposure patterns on the second wafer by performing a fourth exposure process through the reticle;
calculating a first relative error between the first exposure patterns and the second exposure patterns in the first direction, and calculating a second relative error between the third exposure patterns and the fourth exposure patterns in the second direction; and
measuring distortion for the exposure apparatus in the first direction using the first relative error and measuring distortion for the exposure apparatus in the second direction using the second relative error.

2. The method of claim 1, wherein the first exposure process and the second exposure process on the first wafer and the third exposure process and the fourth exposure process on the second wafer are performed in the same exposure apparatus.

3. The method of claim 1, further comprising, before aligning the reticle over the first wafer:
loading the first wafer in the exposure apparatus; and
loading the reticle in the exposure apparatus.

4. The method of claim 1, further comprising, before aligning the reticle over the second wafer:
unloading the first wafer from the exposure apparatus; and
loading the second wafer in the exposure apparatus.

5. The method of claim 1, further comprising, after forming the fourth exposure patterns:
unloading the second wafer from the exposure apparatus; and
developing a photosensitive layer on each one of the first and second wafers.

6. The method of claim 1, wherein each of the plurality of measuring patterns comprises:
a main scale and a sub-scale separated by a first distance in the first direction and a second distance in the second direction, wherein the second distance is sufficiently smaller than either of the first and second pitches to be approximated to 0 in calculations related to the first and second relative errors.

7. The method of claim 6, wherein the main scale and the sub-scale are formed by a square or line and space patterns.

8. The method of claim 6, wherein the first exposure pattern comprises a first main scale pattern and a first sub-scale pattern corresponding to the measuring pattern of the reticle;
the second exposure pattern comprises a second main scale pattern and a second sub-scale pattern corresponding to the measuring pattern of the reticle; and
the second sub-scale pattern of the second exposure pattern is overlaid on the first main scale pattern of the first exposure pattern.

9. The method of claim 8, wherein the first relative error in the first direction is obtained from a distance between the second sub-scale pattern of the second exposure pattern and the first main scale pattern of the first exposure pattern in the first direction.

10. The method of claim 6, wherein the third exposure pattern includes a third main scale pattern and a third sub-scale pattern corresponding to the measuring pattern of the reticle;
the forth exposure pattern includes a fourth main scale pattern and a fourth sub-scale pattern corresponding to the measuring pattern of the reticle; and
the fourth sub-scale pattern of the fourth exposure pattern is overlaid on the third main scale pattern of the third exposure pattern.

11. The method of claim 10, wherein the second relative error in the second direction is obtained from a distance between the fourth sub-scale pattern of the fourth exposure pattern and the third main scale pattern of the third exposure pattern in the second direction.

12. A method of measuring distortion for an exposure apparatus, the method comprising:
aligning a reticle comprising a plurality of measuring patterns over a wafer, wherein the plurality of measuring patterns are separated by a first pitch in a first direction and a second pitch in a second direction;
forming a plurality of first exposure patterns by performing a first exposure process through the reticle;
shifting the reticle by a first distance from a position at which the first exposure process was performed and aligning the reticle over the first wafer;
forming a plurality of second exposure patterns by performing a second exposure process through the reticle;
shifting the reticle by a second distance from a position where the first exposure process was performed and aligning the reticle over the wafer;
forming a plurality of third exposure patterns by performing a third exposure process through the reticle;
calculating a first relative error between the first exposure patterns and the second exposure patterns in the first direction, and calculating a second relative error between the first exposure patterns and the third exposure patterns in the second direction; and
measuring the distortion of the exposure apparatus in the first direction using the first relative error and measuring the distortion of the exposure apparatus in the second direction using the second relative error.

13. The method of claim 12, wherein the first exposure process, the second exposure process, and the third exposure process are performed in the same exposure apparatus.

14. The method of claim 12, further comprising, before aligning the reticle on the wafer:
loading the wafer in the exposure apparatus; and,
loading the reticle in the exposure apparatus.

15. The method of claim 12, further comprising, between forming the third exposure patterns and measuring the first relative error and the second relative error:
unloading the wafer from the exposure apparatus; and,
developing the wafer.

16. The method of claim 12, wherein each of the plurality of measuring patterns comprises:
a main scale and a sub-scale separated by a first distance in the first direction and a second distance in the second direction, wherein the second distance is sufficiently smaller than either of the first and second pitches to be approximated to 0 in calculations related to the first and second relative errors.

17. The method of claim 16, wherein the main scale and the sub-scale are formed by a square or line and space patterns.

18. The method of claim 16, wherein the first exposure pattern comprises a first main scale pattern and a first sub-scale pattern corresponding to the measuring pattern of the reticle;
the second exposure pattern comprises a second main scale pattern and a second sub-scale pattern corresponding to the measuring pattern of the reticle; and
the second sub-scale pattern of the second exposure pattern is overlaid on the first main scale pattern of the first exposure pattern.

19. The method of claim 18, wherein the first relative error in the first direction is obtained from a distance between the second sub-scale pattern of the second exposure pattern and the first main scale pattern of the first exposure pattern in the first direction.

20. The method of claim 16, wherein the third exposure pattern includes a third main scale pattern and a third sub-scale pattern corresponding to the measuring pattern of the reticle;
the forth exposure pattern includes a fourth main scale pattern and a fourth sub-scale pattern corresponding to the measuring pattern of the reticle; and
the fourth sub-scale pattern of the fourth exposure pattern is overlaid on the third main scale pattern of the third exposure pattern.

21. The method of claim 20, wherein the second relative error in the second direction is obtained from a distance between the fourth sub-scale pattern of the fourth exposure pattern and the third main scale pattern of the third exposure pattern in the second direction.
